(19) United States
(12) Patent Application Publication
(10) Pub. No.: US 2008/0308645 A1
(43) Pub. Date: Dec. 18, 2008

(54) FIRE AND WATER SYSTEM

(76) Inventors: Ben Presley, Chico, CA (US); Scott Laine, Chico, CA (US)

Correspondence Address: BLACK LOWE & GRAHAM, PLLC, 701 FIFTH AVENUE, SUITE 4800, SEATTLE, WA, 98104, US

(21) Appl. No.: 11/762,658

(22) Filed: Jun. 13, 2007

(51) Int. Cl. B05B 17/08; F23D 14/00; F24B 1/18

(52) U.S. Cl. 239/17; 126/500; 29/428

(57) ABSTRACT

A fire and water system includes a fire unit and a water unit located in a support structure, such as a stone fire pit assembly. The fire and water system includes flowing water provided and controlled by the water unit and a visible flame provided and controlled by the fire unit. The flowing water and visible flame are juxtaposed or otherwise closely positioned in an aesthetic display above the support structure.

### FIELD OF THE INVENTION

The present invention relates generally to a fire and water system, and more particularly to a fire and water system where a fire unit and a water unit are physically juxtaposed to provide an aesthetically pleasing and functional display.

### BACKGROUND OF THE INVENTION

Outdoor fire pits are well known. Generally, there are three types of outdoor fire pits: an outdoor fireplace, an in-ground or above-ground fire pit that is permanently located (i.e., not sufficiently portable), and portable fire pits. An outdoor fireplace is essentially like an indoor fireplace because it includes a chimney and brick or stone support structure. An outdoor fireplace may be built into or against an exterior wall.

The permanent in-ground or above-ground fire pit may be either sunken into the ground or patio, or it can sit on the ground with raised walls that secure the logs. These types of fire pits typically do not have chimneys, so they should be installed in well-ventilated areas.

Portable fire pit units are becoming increasingly popular because they do not require any installation, and thus there is no need to structurally alter any portion of a yard or house, for example. Also, portable fire pit units are easily transportable and may be placed in the back of a truck or other vehicle. Portable fire pits are typically made out of metal and designed to accommodate smaller fires than built-in fireplaces and permanent fire pits.

Fire tables, which generally include a fire pit embedded in the center of an outdoor patio table, are one of the more recent alternatives to the fire pits described above. Fire tables may be used for entertaining, such as talking with friends seated around the table, eating meals at the table, and even roasting a hot dog or marshmallow while seated at the table. The fire emanating from a fire table is typically fueled by propane or natural gas.

Similar to fire pits, outdoor waterfall systems are also well known. One example is a landscaped rock or stone waterfall system that may drain into a landscaped pond. Typically, these types of waterfall systems take up a fair amount of square footage and are costly to install.

### SUMMARY OF THE INVENTION

A fire and water system includes a fire unit and a water unit located in a support structure, such as a stone fire pit assembly. The fire and water system includes flowing water provided and controlled by the water unit and a visible flame provided and controlled by the fire unit. The flowing water and visible flame are juxtaposed in an aesthetic display above the support structure.

### BRIEF DESCRIPTION OF THE DRAWINGS

The preferred and alternative embodiments of the present invention are described in detail below with reference to the following drawings:

FIG. 1 is an isometric view of a fire and water system according to an embodiment of the invention;

FIG. 2 is an side elevational view of the fire and water system of FIG. 1 having heat resistant fire elements;

FIG. 3 is an isometric view of a water unit for the fire and water system of FIG. 1 according to another embodiment of the invention;

FIG. 4 is a side elevational view of a burner assembly located within a fire and water system according to an embodiment of the invention; and

FIG. 5 is a cross-sectional, schematic view of a fire and water system according to another embodiment of the invention.

### DETAILED DESCRIPTION OF THE PREFERRED EMBODIMENT

In the following description, certain specific details are set forth in order to provide a thorough understanding of various embodiments of the invention. In other instances, well-known structures and methods associated with fire pit assemblies and systems and water fountain assemblies and systems may not be shown or described in detail to avoid unnecessarily obscuring descriptions of the embodiments of the invention.

The following description relates generally to a fire and water system where a fire unit is combined with a water unit in a support structure, such as a stone fire pit structure. The fire and water system includes flowing water provided and controlled by the water unit and an exposed flame provided and controlled by the fire unit. The flowing water and exposed flame are juxtaposed in an aesthetic display.

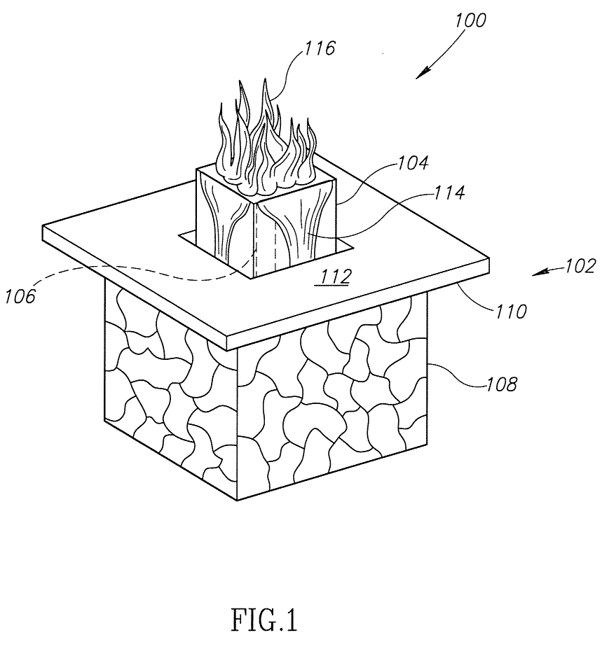

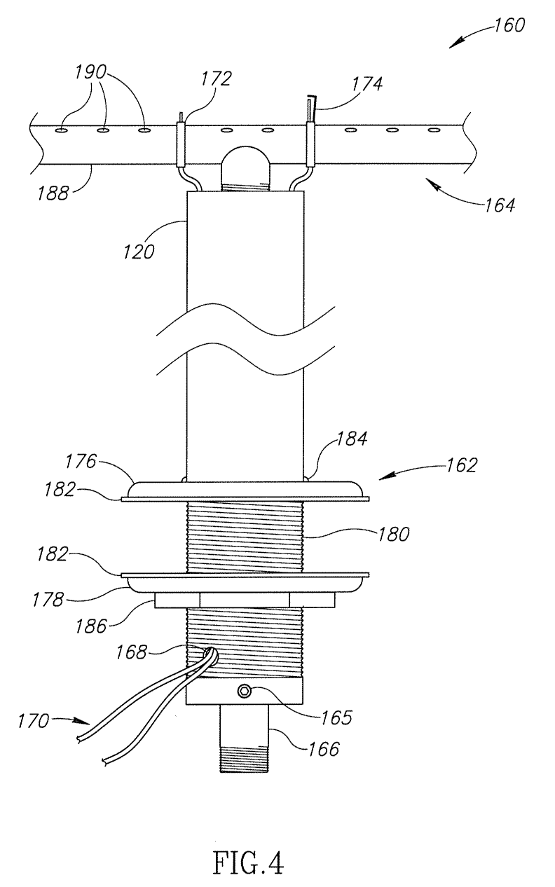

FIG. 1 shows a preferred embodiment of a fire and water system 100 having a support structure 102 with a water unit 104 and a fire unit 106. The support structure 102 includes a base portion 108 and an upper platform portion 110 with an upper surface 112. The base portion 108 may be made from natural stone or rock, may have a veneer stone or rock covering, or some equivalent configuration used on fire pit systems. The upper platform portion 110 may be, but is not limited to, a natural stone slab, for example granite, marble, or some other type of material. The fire unit 106 includes a visible flame 116 extending from a burner assembly 160 (FIG. 4) of the fire unit 106. The water unit 104 includes an amount of flowing or cascading water 114 moving relative to the water unit 104.

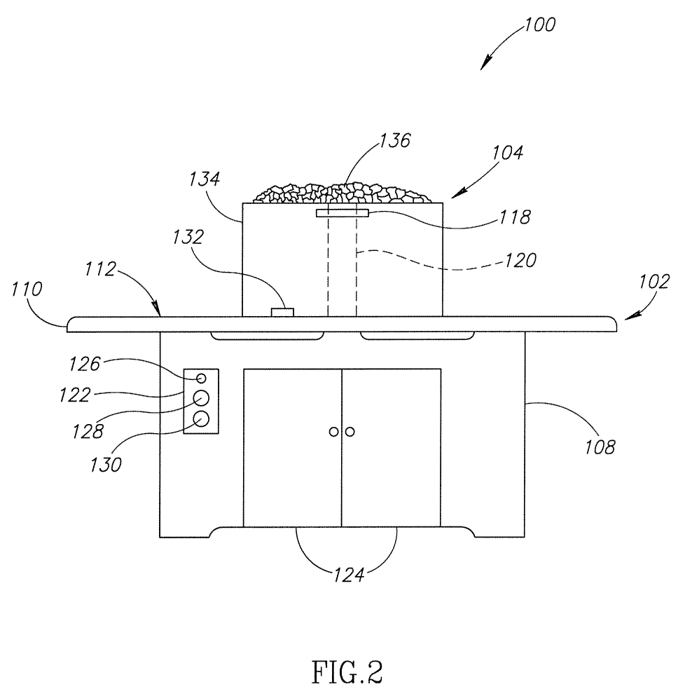

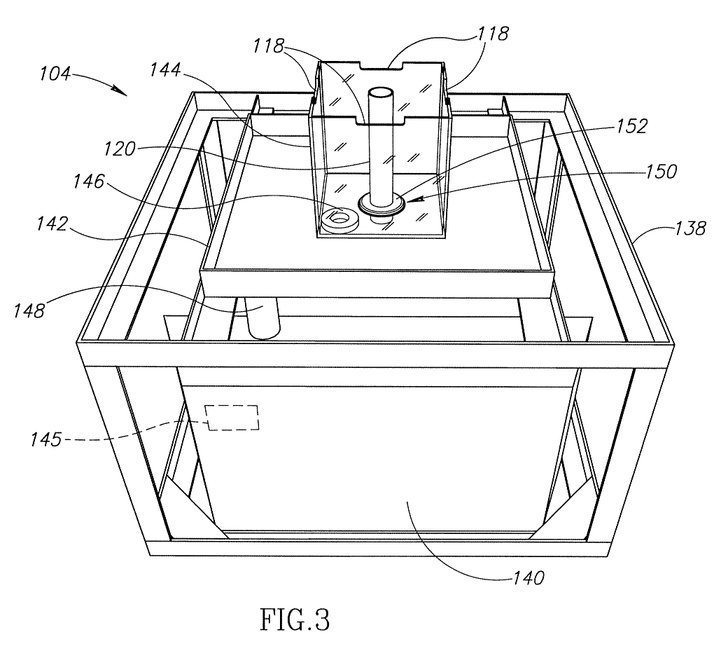

FIG. 2 shows a side elevational view of the fire and water system 100. For purposes of brevity and clarity, the flowing water that exits a water slot 118 when the device is operating is not shown so that a burner tube 120 (FIG. 3) of the fire unit 106 may be more easily identified. The base portion 108 of the support structure 102 includes a control panel 122 and access doors 124.

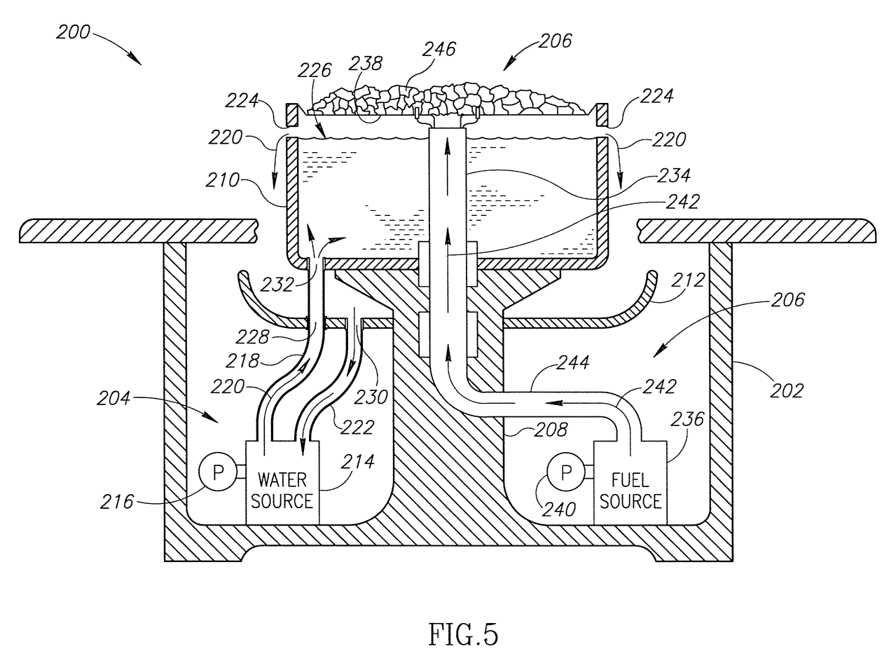

The control panel 122 may include one or more of an igniter button 126 to ignite the burner 164 (FIG. 4) of the fire unit 106 (FIG. 1), a fuel control knob 128 to control the rate of the fuel to the burner 164 (FIG. 4), and a water control knob 130 to control the rate of water through the water unit 104, which may include turning a water pump 216 (FIG. 5) on or off. Other knobs or control devices may be included on the control panel 122, such as an on/off switch that activates various decorative or informational lights. The access doors 124 may be used, by way of example, for accessing portions of the fire unit 106 (FIG. 1), for accessing portions water unit 104 (FIG. 1), for performing maintenance, and for storing and retrieving items located within the support structure 102. The control panel may further include a ground fault interrupter (GFI) switch (not shown) for safety.

In the illustrated embodiment and above the upper surface 112 of the upper platform portion 110, a series of lights 132 are located on a water tank 134 of the water unit 104. The lights 132 may be decorative lights, may operate in conjunction with the control panel 122 to indicate whether a certain feature of the fire and water system 100 is ON or OFF, may indicate whether the water flow to the water tank 134 is above or below a certain threshold flow rate, may indicate a quantity of fuel, or may provide an indication relative to some other information about the fire and water system 100. In one embodiment, at least some of the lights 132 include decorative lights that are controllable with a remote control to have a variety of color and color mode combinations selectable by a user.

The fire unit 106 (FIG. 1) may include heat resistive elements 136 placed or stacked onto the burner assembly. In one embodiment the heat resistive elements 136 are Diamond Fire Glass® manufactured by Diamond Fire Glass. See http://www.diamondfireglass.com. In another embodiment, the heat resistive elements 136 are made from another type of glass, stone, rock, or some other type of ceramic or ceramic alloy material.

FIG. 3 shows the water system 104 supported on a frame 138. The water system 104 includes a holding tank 140, a catch basin 142, and a water tank 144. The holding tank 140 is located beneath the catch basin 142 and is sized to hold an amount of water sufficient to at least partially overfill the water tank 144. A water pump (not shown) moves the water from the holding tank 140 through a water inlet port 146. Once the water tank 144 is filled and the water unit 104 is operating, the water flows out of the water slots 118, as shown in FIG. 1. The catch basin 142 receives the water from the water tank 144 and directs the water back to the holding tank via a catch basin outlet port 148. The water tank 144 includes an opening 150 sized to receive the burner tube 120, which is secured to the tank 144 with a fitting assembly 152. Preferably, the water tank 144 extends above the upper surface 112 (FIG. 2) of the support structure 102 (FIG. 1) so that a substantial portion of the water tank 144 is viewable. In addition, it is preferable, but not necessary, that the water tank 144 have transparent sidewalls and possibly a transparent bottom wall, similar to an aquarium. The water tank 144 may take a variety of forms from a circular to a polygonal shaped tank. The water slots 118 may be configured to provide a variety of cascading water flow effects.

The water source tank can be utilized by initially filling the holding tank 140 using a garden hose. In one embodiment, the holding tank 140 has a volumetric capacity of twelve (12) gallons and is filled by running water into the catch basin 142 located above the holding tank 140 and in fluid communication with the holding tank 140. The catch basin 142 includes a perimeter sufficiently sized to receive the water flowing out of the water tank 144. In one embodiment, the perimeter of the catch basin extends at least five (5) inches past the respective sidewalls of the water tank 144. A fluid level sensor 145 may be located in the holding tank 140 to determine when the holding tank 140 contains an appropriate amount of water for operation of the fire and water system 100. Once the water reaches a threshold level in the holding tank 140, the sensor 145 turns the garden hose off and any overfill may be released from drain tube coupled to the holding tank 140.

FIG. 4 shows a burner assembly 160 having the burner tube 120, the fitting assembly 162, and the burner conduit assembly 164. A bottom portion of the burner tube 120 is coupled to a fuel tube 166, which in turn may be coupled to a fuel line or fuel hose (FIG. 5). An upper portion of the burner tube 120 is coupled to the burner conduit assembly 164, for example with a setscrew 165. The burner tube 120 further includes a lower aperture 168 for receiving wiring 170 for a thermo-coupler 172 and an igniter 174 according to one embodiment of the invention. By way of example, the burner tube 120 may be a brass tube or aluminum tube, such as Prescott tube and the igniter 174 may be battery powered.

The fitting assembly 162 includes flange fittings 176, 178 that threadably engage external threads 180 formed on the burner tube 120. Gaskets 182 are positioned on opposing faces of the flange fittings 176, 178 to prevent water from the water tank 144 (FIG. 3) from leaking through the lower aperture 168. In one embodiment, the upper flange fitting 176 is welded 184 to the burner tube 120 and the lower flange fitting 178 is urged into tight contact with the catch basin 142 (FIG. 3) with a flange nut 186. In this process, the gaskets 182 are compressed to form tight seals with the burner tube 120, the catch basin 142 (FIG. 3), and the water tank 144 (FIG. 3), respectively.

The burner conduit assembly 164 receives and distributes combustible fuel (e.g., propane) from the burner tube 120. In one embodiment, the burner conduit assembly 164 takes the form of a fuel conduit or burner 188 with openings 190 to vent the combustible fuel toward the igniter 174. In a preferred embodiment, the burner 188 is configured and operates similar to the fuel conduits or tubes in a gas barbecue grill. The burner 188 and the openings 190 are shaped and arranged to create the fire 116 (FIG. 1).

Preferably, the burner assembly 160 encases portions of the igniter and thermo-coupler wires 170 and a portion of the fuel tube 166 to prevent water contact with these components. As described above, the water is kept out of the burner tube 120 by the fitting assembly 162. In one embodiment, the burner tube 120 may be raised or lowered relative to the burner 188 using the setscrew 165. The thermo coupler 172 is positioned near the burner 188 and measures the flame temperature. In one example of the invention, the thermo coupler 172 measures a flame temperature over a desired threshold temperature value the fire unit 106 (FIG. 1) remains operational. But once the flame temperature falls below the desired threshold temperature, the fire unit 106 (FIG. 1) automatically shuts off the fuel flow.

FIG. 5 shows a cross-sectional, schematic view of a fire and water system 200. The system 200 includes a support structure 202 with a water unit 204 and a fire unit 206. The support structure 202 includes an internal support member 208 to support components of the water and fire units 204, 206. Other aspects of the support structure 202 are not substantially different then the support structure 102 (FIG. 1) described above, thus the support structure 202 of the illustrated embodiment will not be described in further detail.

The water unit 204 includes a viewable tank 210, a water return or catch basin 212, a water source or holding tank 214, a pump 216, a first hose 218 to carry water 220 from the water source 214 to the viewable tank 210, and a second hose 222 to carry water 220 (represented by the various arrows) from the catch basin 212 back to the water source 214 and thus recycle the water 220. The viewable tank 210 is supported on the internal support member 208. In addition, the viewable tank 210 includes slots or openings 224 that allow the water 220 within the viewable tank 210 to flow out of the viewable tank 210 and into the catch basin 212 after the water 220 reaches a threshold level 226, which is indicated by the wavy line in the illustrated embodiment. Once the water 220 reaches the threshold level 226, the water 220 will flow out of the viewable tank 210 through slots 224, as indicated by water flow arrows 220, and will then into the catch basin 212.

The catch basin 212 includes a first opening 228 to receive the first hose 218 and a second opening 230 to receive the second hose 222. The second hose 222 may be a drain or other type of fluid conduit to drain or otherwise route water back into the holding tank 214 through gravity or other means. The second hose 222 is arranged to receive water 220 from the water return or catch basin 212. The first hose 218 is arranged to pass through the catch basin 212 and seal therewith and then extend up to a third opening 232 in the viewable tank 210 and seal therewith. The pump 216 may be used to increase and then maintain the water pressure to urge the water 220 from the water source 214 into the viewable tank 210.

The fire unit 206 includes a burner tube 234 in communication with a fuel source 236. The burner tube 234 connects to a burner 238. In operation, a fuel pump 240 may be used to pump an amount of fuel 242, such as white gas, kerosene, propane, butane, or another combustible fuel, from the fuel source 236 through a fuel tube 244 and into the burner tube 234. The fuel 242, also represented as arrows, travels through the burner tube 234 and then into the burner 238. The burner 238 includes a plurality of openings 190 (FIG. 4) that allows fuel vapors to rise upward from the burner 238, be ignited by the igniter 174 (FIG. 4), and thus produce the flame 116 (FIG. 1). In addition, the burner 238 may also be used to heat a plurality of heat resistive elements 246.

These and other changes can be made in light of the above detailed description. In general, in the following claims, the terms used should not be construed to limit the invention to the specific embodiments disclosed in the specification and the claims, but should be construed to include all types of fire and water systems, assemblies, devices, and units capable of producing a flame in a juxtaposed relation to water, to include but not limited to fire pits combined with water units that operate in accordance with the claims.

While the preferred embodiment of the invention has been illustrated and described, as noted above, many changes can be made without departing from the spirit and scope of the invention. For example, various types of controls, switches and actuators may be arranged in the fire and water system to achieve similar or slightly different objectives and advantages as described above. Accordingly, the scope of the invention is not limited by the disclosure of the preferred embodiment. Instead, the invention should be determined by reference to the claims that follow.

1. An aesthetic fire and water system comprising:
a support structure;
a fire unit located at least partially within the support structure, the fire unit having a burner assembly configured to burn a combustible fuel and thus produce a flame that emanates from the burner assembly; and
a water unit located at least partially within the support structure.

2. The fire and water system of claim 1, wherein the burner assembly includes an igniter and a burner for burning the combustible fuel.

3. The fire and water system of claim 1, wherein the support structure includes a main opening extending through an upper surface of the support structure.

4. The fire and water system of claim 1, wherein at least a portion of the support structure is made from natural rock.

5. The fire and water system of claim 1, wherein the water unit includes a water tank for receiving water from a water source, the water tank having openings to allow the water to flow out of the water tank, the water tank positioned relative to the burner such that the flame is juxtaposed with respect to the water flowing out of the water tank.

6. The fire and water system of claim 5, wherein the water tank includes an opening that receives a burner tube of the burner assembly.

7. The fire and water system of claim 6, wherein the opening in the water tank is sealed with respect to the burner tube.

8. The fire and water system of claim 5, wherein the water tank includes transparent sidewalls.

9. The fire and water system of claim 1, wherein the water unit further includes a catch basin to receive water flowing from a location proximate the burner assembly of the fire unit.

10. The fire and water system of claim 1, further comprising a plurality of heat resistive elements placed on the burner.

11. A method of manufacturing an aesthetic fire and water system where the system produces fire juxtaposed with water, the method comprising:
supporting a fire unit and a water unit in a support structure, the fire unit having a burner assembly in fuel communication with a fuel source, the water unit having a viewable water tank in fluid communication with a water source; and
positioning a burner of the burner assembly proximate the viewable water tank, wherein ignition of an amount of fuel in the burner produces a flame located proximate the viewable water tank.

12. The method of claim 11, further comprising positioning a burner tube through an opening in the viewable water tank.

13. The method of claim 12, further comprising sealing the burner tube to the viewable water tank to prevent water in the viewable water tank from flowing through the opening.

14. The method of claim 1, wherein supporting the fire unit and the water unit in the support structure includes supporting the fire unit and the water unit in a natural stone support structure.

15. The method of claim 11, further comprising sensing a flame temperature of the flame emanating from the burner.

16. The method of claim 11, further comprising preventing fuel from entering the burner once the flame temperature drops below a desired threshold value.

17. A fire and water system comprising:
support structure for supporting the fire and water system, the support structure having a main opening extending through an upper surface of the support structure;
fire generating means for producing a visible flame, the fire generating means located at least partially within the support structure means, the fire generating means arranged to burn a combustible fuel received in a burner of the fire generating means; and
water flow generating means for producing a flow of water such that the flow of water is released proximate the burner of the fire generating means.

18. The fire and water system of claim 17, further comprising the support structure enclosing a water supply means and a fuel supply means.

19. The fire and water system of claim 17, further comprising water receptacle means for receiving and supporting an amount of water above the upper surface of the support structure, the water receptacle means having transparent sidewalls.

20. The fire and water system of claim 17, wherein the water flow generating means located at least partially within the support structure, wherein the visible flame from the fire generating means appears to emanate from the water receptacle means.
